(19) United States
(12) Patent Application Publication
(10) Pub. No.: US 2003/0076963 A1
(43) Pub. Date: Apr. 24, 2003

(54) System integration for live-venue downloadable music

(76) Inventor: Richard O. Wells, Brentwood, TN (US)

Correspondence Address: Jason A. Bernstein, BERNSTEIN & ASSOCIATES, P.C., Embassy Row 400, Suite 495, 6600 Peachtree Dunwoody Road, N.E., Atlanta, GA, 30328-1649, US

(21) Appl. No.: 10/029,641

(22) Filed: Oct. 22, 2001

(51) Int. Cl. G10H 1/26

(52) U.S. Cl. 381/1; 84/609

(57) ABSTRACT

A system for integrating a sequence of events that transpires during the transformation of a Musical Event into a downloadable computer file. The integration begins with a Production Engineer transforming a received transmission of the Musical Event. The Production Engineer in communication with a LVDM Server transmits the computer file. A LVDM Client in communication with the LVDM Server displays an indicator on a Display notifying a Subscriber of the availability of downloadable computer files. The Subscriber makes a selection and communicates that selection to the LVDM server via his communication device. The Subscriber may communicate requests for downloadable Musical Events via the World-Wide-Web. In this case, the LVDM Client in communication with the Subscriber Web Server provides the connecting mechanism to facilitate the downloading of music computer files to the Subscriber.

### FIELD OF THE INVENTION

In general, the invention relates to a mobile system of partnerships between pluralities of music industry providers. In particular, the invention relates to system integration of Live-Venue Downloadable Music (LVDM). More particularly the invention relates to a system for managing the flow of LVDM between the originating source, the music industry and the consumer.

### BACKGROUND OF THE INVENTION

Historically, the recorded music industry has been in constant turmoil since the late 1990's mainly due to an effort to diversify income dependency from the sale of mass-produced recorded music. The music industry's move away from recorded music may be characterized or determined by the mass appeal of music enthusiasts attending live concerts. Attendees often take the opportunity to see shows multiple times as concert tours move from city to city. As a result many concerts, particularly sold out concerts, are viewed as an “event” not to miss. This is evidenced by the success seen in the sale of merchandise such as T-shirts, caps, jackets etc. The concert performance may last 4-5 hours and be remembered by the attendees through their purchase of merchandise.

The “event” status of these performances creates an emotional attachment between artists and their fans. Due to the unique nature of a concert, aside from the geographical location, size and scope or frequency of acts touring through a particular city, no performance can be replicated in its entirety; therefore, each concert and the resulting recordings of the concert are unique. This is evidenced by the success of impulse buying done by the fans during the concert. The purchase of recorded music, recorded live during the concert performance, is a significant impulse buying opportunity.

The technology to make this buying opportunity a reality must mature from its current state of infancy. There are two factors that represent barriers to the maturation of the buying habits of fans. The first is the availability of terminal devices (portable telephones) that have a music player such as an MP3 player integrated into their design. Although these types of music/telephones seem futuristic, they are a reality with the advent of the EOY 2001 production of these devices. The second and more significant obstacle is the capacity of the national wireless networks to accommodate the need to download such large files. Although not currently available, it is expected that diversification among wireless licensee's may indeed provide an opportunity to take advantage of increased “bandwidth” capacity among vertical suppliers of wireless networks and technology. Further development in alternative technology to cellular/PCS is in the form of unlicensed wireless LAN's, infrared, DBS or GPS. However, these forms of wireless communication do not have the mass appeal and consumer ubiquity needed to execute this strategy.

Attempts have been made to provide fans or consumers with personal fulfillment systems, music delivered via the World Wide Web and advertising embedded into real time information. All of these efforts focus on the technical aspect of commanding and controlling impulse buying of consumers. Historically, consumer(s) impulse buying has not been entirely influenced by technology. Technology certainly is a part of impulse buying but the consumer is still the principle factor in any impulse buy scenario.

Given the multifaceted music industry, the consumer of music industry products, technology and the interdependence required for all of these factors to work in concert it would be desirable to have a network of partnerships, mobile and otherwise, that would enable the consumer to remain in a fixed location, if desired, and the music industry move from place to place, i.e., concerts, to accommodate the needs of the consumer who wish to obtain recorded music as performed live.

### SUMMARY OF THE INVENTION

The present invention is a system integration of a plurality of interdependent discrete music providers that comprise the music industry. The music industry providers may, if desired, be Music Artist(s), Musical Events performed live on stage or in other suitable facilities, fans or Subscribers, Wireless Service Providers, Promoters of the musical concert or performance, Internet Service Providers and the Music Industry. The Music Industry may, if desired, include advertisers, concert promoters, recording distributors and publishing companies of various types involved in the sale and distribution of recorded music.

The system integration of Live-Venue Downloadable Music (LVDM System) forms a partnership of selected interdependent discrete music providers (as discussed above). The partnerships formed enable the wireless Subscriber who is present to witness the LVDM System performance of a Music Artist during the Musical Event, to wirelessly download music selections shortly after being performed to a selected recording medium. It is understood that the Musical Event may, if desired, have a plurality of Music Artists giving multiple performances throughout the Musical Event. It is further understood the Subscriber may, if desired, select one or all of the Music Artists' performances. The Subscriber may, if desired, download the Musical Event via an Internet Service Provider at a selected later date. The recording medium used to download the musical performance shortly after being performed may, if desired, be any convenient type of recording device known in the art of recording devices. The partnerships further extend to the business agreements, i.e., right-to-use license to record companies, publishing companies, artists, concert promoters, venue owners, sound reinforcement companies and infrastructures formed within the Music Industry to deliver live-venue downloadable music to the Subscriber(s).

The partnerships formed within the LVDM System culminate in the Musical Event. The Subscriber, via any type of convenient wireless communication device, who is in communication via the Wireless Service Provider indicates or transmits a stimulus to the LVDM System requesting participation in the Musical Event. The LVDM System authenticates the Subscriber and grants the Subscriber participation in the Musical Event.

The stimulus transmitted to the LVDM System is attainable via a display viewed by the Subscriber during the Musical Event. The Subscriber makes a selection of at least one artist's performance and transmits the request to the LVDM System. The Subscriber may, if desired, make his selection of the desired music via the Internet Service Provider at a later date and at his convenience.

When taken in conjunction with the accompanying drawings and the appended claims, other features and advantages of the present invention become apparent upon reading the following detailed description of the embodiments of the invention.

### BRIEF DESCRIPTION OF THE DRAWINGS

The invention is illustrated in the drawings in which like reference characters designate the same or similar parts throughout the figures of which:

FIG. 1 illustrates a top level object model schematic view of the preferred embodiment of the present invention,

FIG. 2 illustrates a detailed schematic view of FIG. 1,

FIG. 3 illustrates a flow chart schematic view of the operational functions of FIG. 2.

### DETAILED DESCRIPTION OF THE INVENTION

Before describing in detail the particular improved system integration of Live-Venue Downloadable Music (LVDM) in accordance with the present invention, it should be observed that the invention resides primarily in the novel integration of various aspects of the music industry. The present invention further resides in the unique data structures of the system software and not in the combination of conventional system apparatus. Examples of a system apparatus are a computer, telephone network, PBX system, portable sound and production equipment or a communication system linking the system apparatus by a local area network, wide area network, or Internet network.

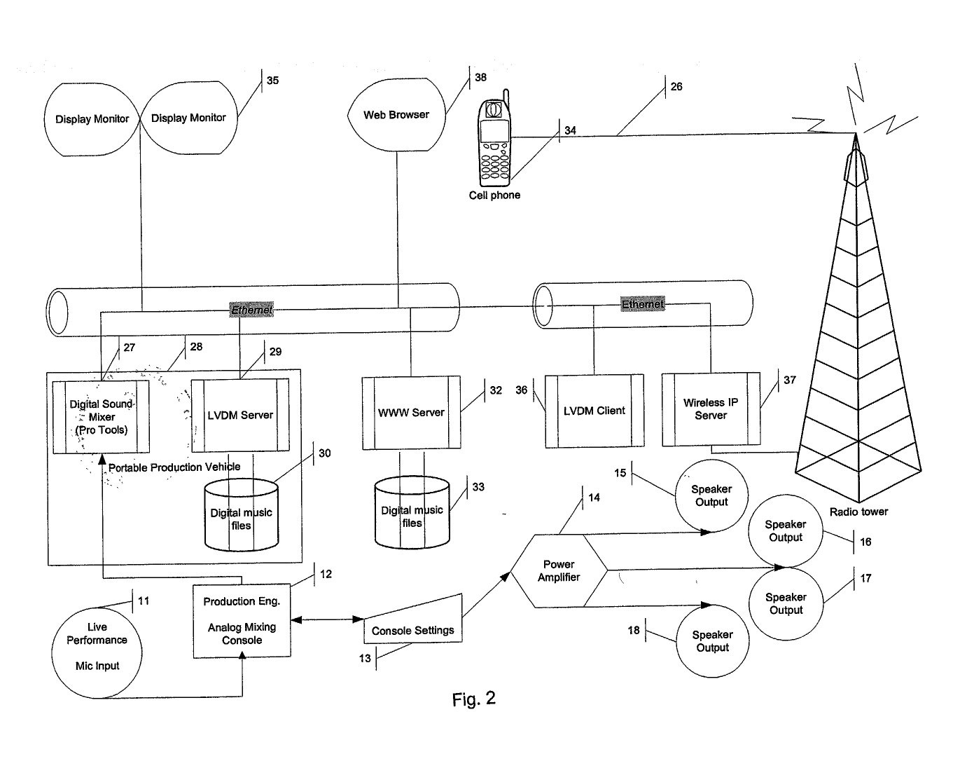

The present invention utilizes system integration of discrete music industry systems, subsystems, and components. The music industry systems, subsystems and components delineated herein are well known in the music industry. An example that is well known in the art of music systems and components is the Live Performance 11, FIG. 2. The Live Performance 11 may, if desired, be instrumental, vocal, or any other form of artistic performance. The Live Performance 11 is amplified through an analog amplification process. The analog amplification process may, if desired, include speakers, microphones, power amplifiers and a sound mixing board. The analog signal is broadcast in stereo over the loudspeakers once it has passed through the Mixing Board 12 for proper sound equalization (EQ). The production engineer operates the Console 13 and controls all EQ settings for each microphone and its Sound Amplification 14 to the house and monitor speakers 15, 16, 17 and 18. The performance is not in a “digital state” when managed by the production engineer, thus it is not in a manageable file format. It is simply a stream of amplified sound reproducing the input of the stage microphones and is expressed in analog signals.

The invention is not in the particular detailed configuration of the system apparatus but in the system integration or command and control thereof. Accordingly, the data structures, command, control, and arrangement of the present invention have, for the most part, been illustrated in the drawings by readily understandable block diagrams and flowcharts. The drawings show only those specific details that are pertinent to the present invention in order not to obscure the disclosure with structural details which will be readily apparent to those skilled in the art having the benefit of the description herein.

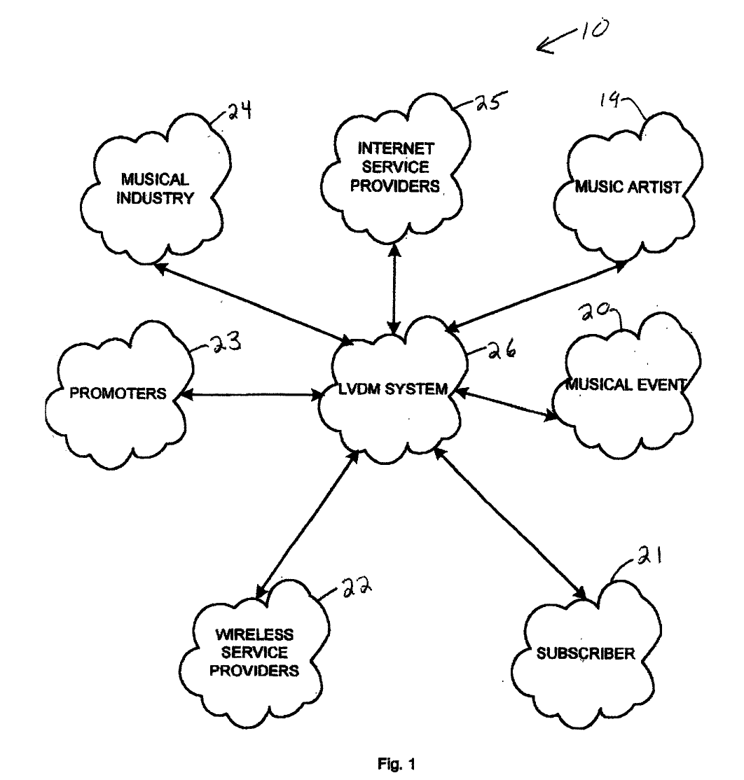

An overview of the present invention: The present invention 10, FIG. 1 is system integration of a plurality of interdependent discrete musical providers that comprise the music industry. The music industry providers may, if desired, be Music Artist(s) 19, Musical Events 20 performed live on stage or in other suitable facilities, the fans or Subscribers 21, Wireless Service Providers 22, Promoters 23 of the musical concert or performance, Internet Service Providers 25 and the Music Industry 24. The Music Industry 24 may, if desired, include advertisers, concert recording distributors and publishing companies of various types involved in the sale and distribution of recorded music.

The system integration of Live-Venue Downloadable Music (LVDM System) 26, FIG. 1 forms a partnership of selected interdependent discrete musical providers (as discussed above). The partnerships formed enable a Subscriber 21 who is present to witness the LVDM System 26 performance of a Music Artist 19 during a Musical Event 20 to wirelessly download music selections shortly after they are performed to a selected recording medium. The Subscriber 21 may, if desired, download the Musical Event 20 via an Internet Service Provider 25 at a selected later date. It is understood that the Musical Event 20 may, if desired, have a plurality of Music Artists 19 giving multiple performances throughout the Musical Event 20. It is further understood the Subscriber 21 may, if desired, select one or all of the Music Artists' 19 performances. The medium used to download the selected musical performance(s) shortly after they are performed may, if desired, be any convenient type of playback device known in the art of playback devices. Examples of are an MP3 player or similar terminal device for playback after a selected performance is complete. Due to the unique experience and creative nature of each live performance, the Subscriber 21 may keep and replay their most memorable moments of a concert. The partnerships formed further extend to the business agreements i.e., right-to-use license to record companies, publishing companies, artists, concert promoters, venue owners, sound reinforcement companies and the infrastructure formed within the Music Industry 24 to deliver live-venue downloadable music to Subscribers 21.

The partnerships formed within the LVDM System 26 culminate in a Musical Event 20. The Subscriber 21, via any type of convenient wireless communication device, who is in communication via the Wireless Service Provider 22 indicates or transmits a stimulus to the LVDM System 26 requesting participation in the Musical Event 20. An example of a communication playback device is a cellular telephone. The LVDM System 26 authenticates the Subscriber 21 and grants the Subscriber 21 participation in the Musical Event 20.

The stimulus transmitted to the LVDM System 26, FIG. 1 is attainable via a display viewed by the Subscriber 21 during the Musical Event 20. The Subscriber 21 makes a selection of at least one artist's performance and transmits the request to the LVDM System 26. The Subscriber 21 may, if desired, make multiple requests and receive multiple selections. The Subscriber 21 may, if desired, make his selection of musical performances via the Internet Service Provider 25 at a later date and at the Subscriber's 21 convenience.

A more detailed discussion of the present invention 10, FIG. 2: The LVDM System 26 via the Portable Production Vehicle 28 present at the live performance receives the audio transmissions from the analog public address sound system (as discussed above) and converts the analog signals into digital signals via a Digital Sound Mixer 27 utilizing any convenient technique or suitable software. An example of sound-mixing software is Pro Tools, available to production engineers involved in sound recording. The Digital Sound Mixer 27 enables the standard mixing techniques to be applied in order to ensure quality sound reproduction. The Digital Sound Mixer 27 is used to digitize, format, mix and compress the signal into a computer file. The digital sound mixer 27, a LVDM Server 29 and digital Music files Database 30 may, if desired, be located in the Portable Production Vehicle 28 that travels from venue to venue in support of the live performances.

The computer file is then uploaded and stored on the LVDM Server 29, FIG. 2 by any convenient application software. The computer file is assigned file reference designators to identify attributes of the live performance. Examples of the designators are log ID, date, time, venue, act, file size, file type and compression techniques used to compress the computer files.

Generally, the uploading and compression times will extend beyond the length of individual or selected live performance. The LVDM System 26, FIG. 2 implements parallel processes in the conversion, uploading, and compression routines. Thus, multiple performances may be converted, uploaded and compressed simultaneously allowing the timely delivery of performances to the Subscriber's 21 Communication Device 34.

Once converted from an analog signal, the computer file containing the live performance is uploaded to a Subscriber Web Server 32, FIG. 2 and stored in Archive Database 33. This process is an automated process subject to a checklist of various criteria. The file will be assigned the following identification information; log ID, date, time, venue, act, file size, file type and compression techniques used to compress the files.

Uploading and compression times will extend beyond the length of the live performance. The LVDM System 26, FIG. 2 implements parallel processing in the conversion, uploading, and compression routines. Thus, multiple performances may be converted, uploaded and compressed simultaneously.

The LVDM Server 29 provides a platform to command and control the network activities of a Display Monitor 35, LVDM Client 36, Subscriber Web Server 32 and the third party Wireless IP Server 37. The LVDM Server 29 assigns tracks and communicates to nodes on the network. The LVDM Server 29 creates and manages performance identification(s) that represent the individual performance of a specific musical composition performed during the live performance. The performance identification may, if desired, be any convenient symbology that is readily understandable by the audience in attendance. Examples of performance identification symbology are numeric and alphanumeric symbols. The LVDM Server 29 performance identification is presented for viewing on the Display Monitor 35 to the audience in attendance. The significance of the performance identification on the Display Monitor 35 has no meaning except to Subscribers(s) 21. The Display Monitor 35 gives the Subscribers 21 the information needed to select a particular performance(s) for which the Subscribers 21 wish to initiate a download into their portable mobile terminal devices.

The interactivity between the LVDM Server 29, FIG. 2 and LVDM Client 36 is the relationship between the wireless network, which is a geographically fixed network and the live performance venues throughout the country that are geographic variables. Simply put one environment is constantly moving and the other is fixed. Additionally, both the LVDM Server 29 and LVDM Client 36 command and control all aspects of the LVDM System 26. Examples of various aspects of the LVDM System 26 are storage, archiving and backup of all performance files, digital rights management, security of performance files from unauthorized users, protocol and interfaces to the wireless network, billing data necessary for carriers to bill Subscribers 21 for downloads, access and download of performance files from the Internet, access and download of performance files from the Wireless network and coordination of all the elements of the system.

In operation the Subscriber(s) 21 may, if desired, communicate with the LVDM System 26, FIG. 1 online via the World-Wide-Web with any convenient Web Browser 38 or access the LVDM System 26 directly via the World-Wide-Web or via the Wireless IP Server 37 while attending the Musical Event 20. The Subscriber 21 is enabled to download a performance performed live at the Musical Event 20. The Subscriber 21 while attending the Musical Event 20 initiates the download process either to his recording device, designated email account or some other user designated digital vault. Additionally, downloading of performance computer files may, if desired, occur online via a terrestrial link to the Internet and in-turn a secure link to the Subscriber Web server 32 containing the performance computer file(s) on the Archive Database 33.

A monthly or annual subscription fee will be charged that will cover the cost of n number of Musical Events 20 downloaded, as purchased from the LVDM System 26, as well as file swapping among other Subscribers 21. A community of Subscribers 21 is created and characterized as consumers of “Musical Trading Cards”, e.g. baseball trading cards, in which a bartering approach will be used to swap various performances of Music Artists 19. The community of Subscribers 21 will maintain a presence on the web and have secure access to performance computer files and other services related to swapping performance computer files. Computer file swapping may be done on a one-for-one basis. Barter, exchange and swapping of files will be encouraged between Subscribers 21.

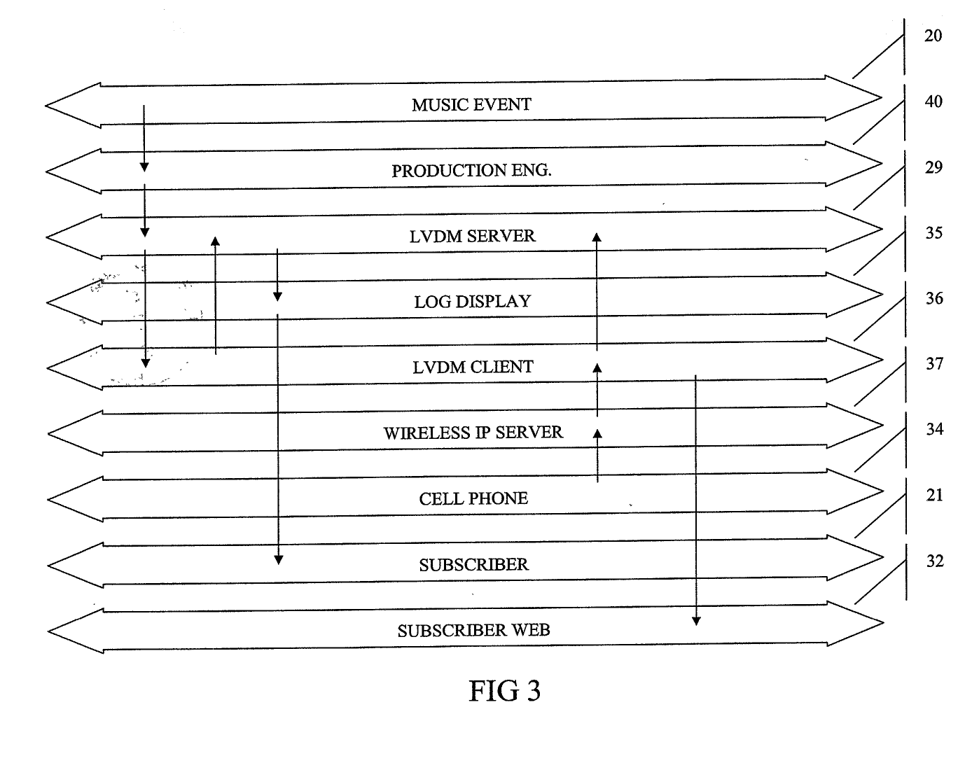

A logical flow of the operation of the present invention 10, FIG. 3: The sequence of events that transpires during the transformation of the Musical Event 20 into a downloadable computer file to the Subscriber 21 begins when the Production Engineer 40 receives the musical content of the Musical Event 20 in analog signal form. The Production Engineer 40 transforms the analog signals into digital signals suitable for transmission or storage via the LVDM Server 29 and associated Digital Music database 30. The recorded Musical Event 20 is online and ready to be downloaded to the Subscriber 21 via the LVDM Client 36. The LVDM Client 36 in communication with the LVDM Server 29 displays an indicator on the Display Monitor 35 notifying the Subscriber 21 of the availability of downloadable computer files. The Subscriber 21 makes a selection and communicates that selection to the LVDM server 29 via his Digital Communication Device or Cellular Telephone 34, Wireless IP Server 37, and the LVDM Client 36. The Subscriber 21 may, if desired, communicate requests for downloadable music via the World-Wide-Web. In this case, the LVDM Client 36 in communication with the Subscriber Web Server 32 provides the connection mechanism to facilitate the downloading of music computer files to the Subscriber 21.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims, means-plus-function clause is intended to cover the structures described herein as performing the recited function and not only structural equivalents but also equivalent structures. All patents, applications, publications and other documents referred to herein are incorporated herein by reference.

I claim:

1. A system for integrating a plurality of interdependent discrete musical providers, comprising the steps of:
a) forming a partnership of selected musical providers;
b) formulating a musical event from said formed partnership;
c) receiving a stimulus indicating a subscriber is in communication with said partnership;
d) requesting participation in the musical event by said subscriber;
e) granting said subscriber participation in said musical event by said partnership;
f) displaying at least one indicator of a downloadable file derived from said musical event;
g) selecting said indicator by said subscriber; and
h) receiving said downloadable file by said subscriber.

2. The system for integrating a plurality of interdependent discrete musical providers of claim 1 step a) of forming a partnership of selected musical providers, wherein said musical providers are at least one of the following: artists, wireless service providers, promoters, and production engineers.

3. The system for integrating a plurality of interdependent discrete musical providers as of claim 2 step b) of formulating a musical event, wherein said music event culminating in at least one live musical performance of selected partners.

4. The system for integrating a plurality of interdependent discrete musical providers of claim 3 step c) of receiving a stimulus indicating a subscriber is in communication with said partnership, wherein receiving said stimulus via wireless means.

5. The system for integrating a plurality of interdependent discrete musical providers of claim 3 step c) of receiving a stimulus indicating a subscriber is in communication with said partnership, wherein receiving said stimulus via landline means.

6. The system for integrating a plurality of interdependent discrete musical providers of claim 3 step c) of receiving a stimulus indicating a subscriber is in communication with said partnership, wherein said subscriber is an enrolled user of said musical event.

7. The system for integrating a plurality of interdependent discrete musical providers of claim 6, wherein step e) of granting said subscriber participation in said musical event by said partnership comprises authenticating said subscriber's enrollment in said musical event.

8. The system for integrating a plurality of interdependent discrete musical providers of claim 7 step f) of displaying at least one indicator of a downloadable file derived from said musical event, wherein said indicator represents a selected live musical performance witnessed by said subscriber.

9. The system for integrating a plurality of interdependent discrete musical providers of claim 8 step f) of displaying at least one indicator of a downloadable file derived from said musical event, wherein said downloadable file contains compressed data derived from said selected musical performance.

10. An article of manufacture, comprising:
a) a computer usable medium having computer readable program code means embodied therein for causing a response to a subscriber, said computer readable program code means in the article of manufacture comprising:
b) computer readable program code means for causing a computer to selectively transform a musical event into a downloadable computer file; and
c) computer readable program code means for causing a computer to selectively transmit said downloadable computer file to said subscriber.

12. A computer data signal embodied in a transmission medium, the transmission medium being a product of wireless bi-directional communication between a subscriber and at least one remote client/server, comprising:
a) a subscriber via an indicator embedded in the transmission medium requesting a downloadable computer file, comprising a musical event; and,
b) at least one client/server responsive to said transmitted indicator embedded in the transmission medium,
said musical event being transmitted to said subscriber by at least one remote facility client/server, whereby the remote facility transceiver transmits said musical event embedded in the transmission medium.
